(19) United States
(12) Patent Application Publication
(10) Pub. No.: US 2005/0035189 A1
(43) Pub. Date: Feb. 17, 2005

(54) Reveel-IT conference support system

(76) Inventor: Michael A. Haddad, Gaithersburg, MD (US)

Correspondence Address: Michael Haddad, 18945 Cross Country Lane, Gaithersburg, MD, 20879, US

(21) Appl. No.: 10/944,347

(22) Filed: Sep. 20, 2004

Related U.S. Application Data
(63) Continuation-in-part of application No. 10/330,981, filed on Dec. 30, 2002.

(51) Int. Cl. G06F 7/00

(52) U.S. Cl. 235/376

(57) ABSTRACT

The invention relates to the following fields: 1—High Tech application 2—Conference support 3—Attendees badging and events admission process 4—Using the Reveel-IT appliance to read attendee information on the fly. 5—System applicability in small to large events, and for all types of events.

### CROSS-REFERENCE TO RELATED APPLICATIONS

This application is in continuation in part of application Ser. No. 10/330,981 filed on Dec. 30, 2002.

### REFERENCE TO SEQUENCE LISTING, A TABLE, OR A COMPUTER PROGRAM LISTING COMPACT DIST APPENDIX

Due to the proprietary nature of the software program, source code is not included in the application in a separate disk.

The different parts of the program are as follow:
1—A user interface that controls up to 3 COM ports. It interacts with Reveel-IT Appliance as well as the printers and responds to the user commands.
2—A window that automates the collection and displaying of data read from an ID such as drivers license, credit card, personal store cards, INS card, government and military IDs.
3—A graphics package for importing graphics, designing, previewing and printing guests Badges.
4—Facilities to automatically locate pre-registration records, as well as search tools for manually searching for a record.
5—Other system management tools for logging in and managing system particulars, creating users and setup system access permissions.
6—Tools to read barcodes from CSS printed badges
7—Tools for importing and exporting, backing up and restoring data.

### BACKGROUND OF THE INVENTION

The existing systems available in the market for conference organizers' use do not offer a high level of automation and process efficiency, and therefore keep organizers' tasks highly manual. Badges have to be pre-printed ahead and brought to the conference room, placed on tables for attendees to find their badges.

CCS helps events and conferences organizers cope with the increased difficulties of managing events and attendee's admission, taking into consideration their level of participation, such as staff, industry, government, state, exhibitors, speakers, and more.

As for the exhibitors, EP package allows for an efficient data collection process targeted at booth visitors in order to provide exhibitors with additional marketing tools: A targeted mailing list.

The different parts, subject of this utility patent, have been designed to carry on certain tasks:
1—The CSS software program is the controlling body of the system that collects data, saves data, responds to commands, and provides reporting and searching utilities. The program runs on a 486-based PC.
2—An EP software package that enhances exhibitors marketing efforts

Other parts of the systems are used to perform required tasks:
1—Reveel-IT appliance, part of application Ser. No. 10/330,981 filed on Dec. 30, 2002
2—Color plastic badge printers
3—2″×3.5 name badges
4—Plastic badge holders with clips or pins
5—Serial to USB adapters
6—USB Hubs
7—A barcode gun included in the EP package

### BRIEF SUMMARY OF THE INVENTION

Reveel-IT CSS provides an efficient tool for conferences and events organizers to manage events and attendees admission. It includes data importing and exporting facilities, graphics tools for designing 2-sided badges, tools to automate the data collection and guest record matching, tools to efficiently perform onsite registration, process charge card payment, and process admission. Features include:
Printing of a barcode on each badge
Allowing the exhibitors to read badges barcodes using our Reveel-IT EP package
Allow the exhibitors, using the EP package, to export collected booth visitors data and obtain a targeted mailing list from the conference organizer.

### BRIEF DESCRIPTION OF THE SEVERAL VIEWS OF THE DRAWING

The drawings included are computer printouts of windows screens from the different parts of the system.

### DETAILED DESCRIPTION OF THE INVENTION

The proposed system solves the problem of admitting, and controlling attendees' admission to an event, while providing an additional revenue stream to the event organizer, by using the reverse side of the badge as an advertising board for paying advertisers. Furthermore, a barcode is printed on the front of the badge, which is then read by exhibitors, using a barcode gun. This collection of data allows exhibitors to obtain a targeted mailing list from the conference organizer.

### Conference Support System

This is how the process works
System administrator creates a list of online registered individuals from their website database. This file is a comma delimited file and can contain information in any order.
System administrator specifies in the system the ordering of the data in the import file. Administrator can then import the registration data into the system.
The registration data contain a field specifying the level of participation for each individual, such as
   Staff
   Exhibitor
   Committee
   Speaker
   Government
   State
   Other . . .
Administrator designs the badge graphics for each participation level
Administrator imports logo and graphics into the system to be used in the badge design
Administrator can specify design parameters for each piece of graphics to be printed on the badge. These parameters include:
   Items location on the badge
   Item color
   Fonts
   Font types
   Characters size
   Selective printing of barcodes
   Live editing of the badge content for an improved level of customer satisfaction
Administrator designs the advertisements graphics for the reverse side of the badge
Administrator pre-prints the reverse side of the badges before the event.
Administrator specifies the different level of pricing for all participation levels.
Administrator specifies the merchant credit card processing information
Administrator sets the system manager code
Administrator Create users
Administrator customizes the data collection window view by specifying which data to collect, which data to view and more.
Administrator specifies the printers used in the system. CSS software supports unlimited number of printers. Print jobs are submitted to the printers successively, one after the other, therefore reducing the amount of time needed to wait for a badge print
Administrator imports an event attendance agreement file into the system
Administrator can obtain instant status reports
During the event, attendee uses a driver's license, a government ID, a credit card, a personalized store card, an INS card, or a military ID, to swipe it or scan it depending on the encoding type available on the card.
Attendee data is collected and matched against exiting pre-registration.
When a pre-registration exists, the system instantly displays the badge graphics on the screen. Editing capabilities allow for instant changes and redisplay. Once approved by the customer, a badge is printed on one of the available printers.
When no match exists, a search window opens to perform a search on different fields. A mismatch may occur when a registered attendee misspelled their name or is different than what is shown on the read ID. When the pre-registration record is found, the badge is shown and edited as above.
For onsite registration, attendee presents an id to the Reveel-IT appliance, and fills up a color-coded section for additional data collection. The amount to be charged for admission is also determined in the color-coded section to be filled.
When the onsite registration button is clicked, a credit card terminal opens and invites the attendee to swipe a charge card. Once the card is swiped, the system establishes a session with the credit card merchant processor, charges the card the proper amount, prints two copies of the attendance agreement, then displays a badge to be edited and printed.
System supports First Data credit card processing platforms.
When an attendee tries to get re-admitted for the second time, the system flags administrator of a previous attendee existing admission record. Administrator may allow a second reprint of the badge by entering the manager code as requested.

The system collects:
Name
Address Line 1
Address Line 2
City
State
Zip
Country
Person or department to visit
ID Type
Gender
Weight
DOB
Height
Time In
Time Out

This information is obtained automatically using the swipe or scan of a driver's license.

Other information needed to complete the onsite registration process, are color-coded and can be entered by the attendee, or otherwise, for pre-registration records, can be imported from a comma delimited file.

Computer Printouts and Brief Functional Description

[image]

Import Settings Window.

Import file record description is specified here. Event information is also specified in this window.

This window also allows for an upload of an attendance agreement file that will be included in the agreement printout for onsite attendee registration.

[image]

Data Import.

Allows administrator to import online pre-registration data from an external comma delimited format which description was entered in the settings window described earlier.

[image]

Badge Text and Badge Color Customization Window.

Allows system administrator to select a participation level and a graphics item to be customized. Different badges are printed for the different participation levels and, for each participation level, each graphic item, to be printed, is also individually customized. Participation levels drop down is obtained from imported guest pre-registration data.

[image]

Logo and Graphics Import Window

This window allows administrator to import graphics to be printed on the badge. The location of each graphic can be selected and a preview of the selected graphic is instantly shown on this window.

[image]

At the start of the customization process, a pre-registration list is shown and a record is selected for badge previewing. After any change, the preview screen pops up to show the system administrator the effect of the change.

[image]

Alert Window

Provides an instant verification of admission status and alert system administrator that an individual was already admitted, thus cutting down on duplicate badge issues. Administrator or manager can only authorize a duplicate issue by entering a manager code in this window.

[image]

Manager Code Setting

This window allows administrator to set manager code.

[image]

Customization of Data Collection Fields.

Administrator can select which fields should be collected or viewed or both.

[image]

Mailing List Provider Window

This window allows conference organizers to import data collected by exhibitors and then submit this information to obtain a targeted mailing list.

[image]

Processor and Merchant Info Settings

Administrator enters all required information to prepare the system to process and charge automatically credit cards for onsite registration.

[image]

Payment Information

Administrator enters a description and amount to be charged for that item. This list of payment information appears as a drop down menu in the data collection window and that helps the system determine the amount to process when charging a charge card.

[image]

Printer Selection

This window shows a list of all printers installed on the system and allows the system administrator which printers to use for printing badges. An unlimited number of printers can be used and the system will cycle through all printers, submitting jobs to all of them successively. It is assumed that there is one other regular printer installed on the system and set as default. This printer will be used for printing event agreements and payment information.

[image]

Restore System Backup Data

This window alerts the user of a dangerous restore operation unless a previous backup was performed.

[image]

Users Management

Administrators can create and delete users and allow the proper permission level for each user.

An Optional Feature Offered.

Live video capture of the attendee waiting area and instant capture of attendee picture for storing on the system, and for printing on a guest badge.

[image]

Instant Reporting

Reports can be generated at any time to review the status of admissions, and other important information

Exhibit Package—EP

Reveel-IT Exhibit package collects data from bar-coded badge issued by CSS software.

[image]

Reading Status Window

This window informs exhibitor through a flashing red signal that the barcode reading was successful.

[image]

Collected Data Export Window

After the show, exhibitors use this window to export data to a removable media that will be provided to the event organizer so as to obtain a targeted mailing list for all booth visitors.

1- Reveel-IT CSS & EP Software Package:
a. The mix of features and technology included in the CSS Package and accompanying EP package. This mix provides an efficient and automated tool to manage events and conferences and allow attendees to preview badges and live print badges at the conference site, using an unlimited number of plastic badge printers, to shorten the waiting period for each attendee to obtain an entry badge. CSS uses the Reveel-IT appliance (included in application Ser. No. 10/330,981). CSS supports reading of drivers license encoding, government and military Ids, credit cards, INS cards, personalized store cards, to automate the collection of data.
b. Reveel-IT EP Software: collects visitor badges data to allow the creation of a targeted mailing list.

2- Printing of traceable barcodes on event admission badges for targeted mailing list creation purposes and printing of advertisements on the reverse side of events badges through a pre-print process, before the event.
